(19) United States
(12) Patent Application Publication
(10) Pub. No.: US 2025/0064155 A1
(43) Pub. Date: Feb. 27, 2025

(54) A WEARABLE FOR CHILDREN WHILE PLAYING

(71) Applicant: Marwa IBRAHIM GHULAM MURAD ALI, Dubai (AE)

(72) Inventors: Marwa IBRAHIM GHULAM MURAD ALI, Dubai (AE); Abdulla IBRAHIM GHULAM MURAD ALI, Dubai (AE); Roudha IBRAHIM GHULAM MURAD ALI, Dubai (AE); Mehdi FARZPOURMACHIANI, Rasht (IR); Ali FARZPOURMACHIANI, Rasht (IR)

(21) Appl. No.: 18/721,683

(22) PCT Filed: Jan. 29, 2023
(86) PCT No.: PCT/IB2023/050755

§ 371 Date: Jun. 19, 2024

(30) Foreign Application Priority Data
Feb. 5, 2022 (TR) 2022001488

(51) Int. Cl. A41D 31/04; A41D 11/00

(52) U.S. Cl. CPC A41D 31/04; A41D 11/00

(57) ABSTRACT

A method is related to a wearable clothing for children to protect them against hazardous electromagnetic waves radiated from tablet and/or mobile phone and/or laptop and/or game-net and/or game-pad. The wearable clothing is made by anti-radiation and anti-electromagnetic fiber and is usable in all season and anywhere at any time.

### TECHNICAL FIELD

This invention generally relates to wearable for children and more particularly to a wearable clothing that children wear to protect them against electromagnetic waves while they are playing by tablet and/or mobile phone and/or laptop and/or game-net and/or game-pad.

### SUMMARY OF INVENTION

In accordance with certain preferred embodiment of present invention, this disclosure proposes a wearable for children while playing. The wearable clothing is made of anti-radiation and anti-electromagnetic waves fibers where an element enters into fabric with a special chemical technique and make the wearable clothing resistant to electromagnetic radiation. Said element is an element selected from row 6 of chemical table consisting of lead, gold, mercury, platinum, etc. The most resistant elements are used to deal with radiation in the construction of anti-electromagnetic radiation wearable clothing.

Various geometric shape and design are used for said wearable clothing for children without limitation in type, shape and size.

Said wearable clothing can be used by children, teenagers and anyone that uses tablet and/or mobile phone and/or laptop and/or game-net and/or game-pad anywhere and anytime. The important features of the wearable clothing are anti-electromagnetic radiation, light weight, flexible, having radiation resistance in all regions of the wearable clothing, having high durability in anti-radiation and anti-electromagnetic waves properties.

### BRIEF DESCRIPTION OF DRAWINGS

FIG. 1 Shows the invention generally (schematically).

FIG. 2 Shows the invention generally (schematically).

FIG. 3 Shows the invention generally (schematically).

### DESCRIPTION OF EMBODIMENTS

The wearable clothing is usable in all seasons of a year and it's possible to wear it anywhere including inside a car, inside a kindergarten, bedrooms, in picnic, in airplanes, in trains, etc. Also, it's easy to transport.

It's possible to design the wearable clothing in any size and it's usable after sewing, so it doesn't have limitation in size.

Because of using the wearable clothing electromagnetic radiation is more under control.

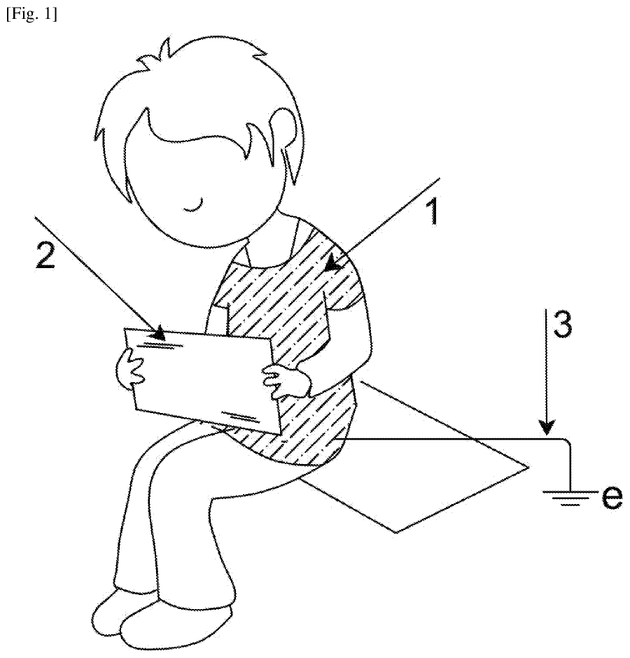

One embodiment of the invention is shown in FIG. 1, schematically. In FIG. 1, (1) is the wearable clothing, (2) is the tablet and/or mobile phone and/or laptop and/or game-net and/or game-pad, and (3) is a ground wire.

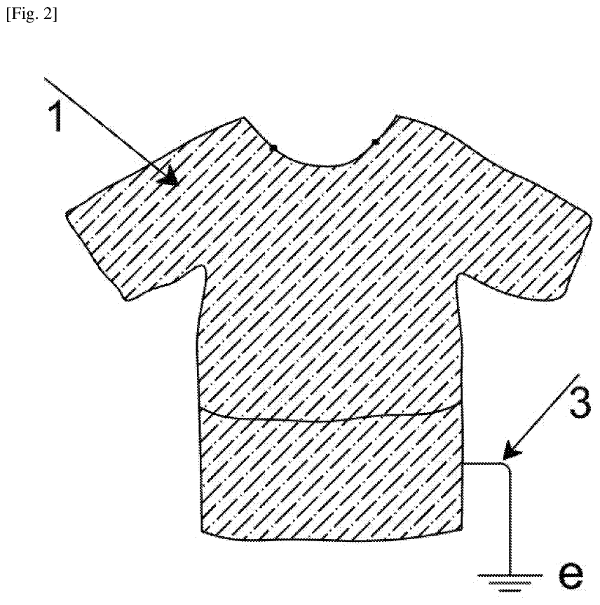

Another embodiment of the invention is shown in FIG. 2, schematically. In FIG. 2, (1) is the wearable clothing, and (3) is the ground wire.

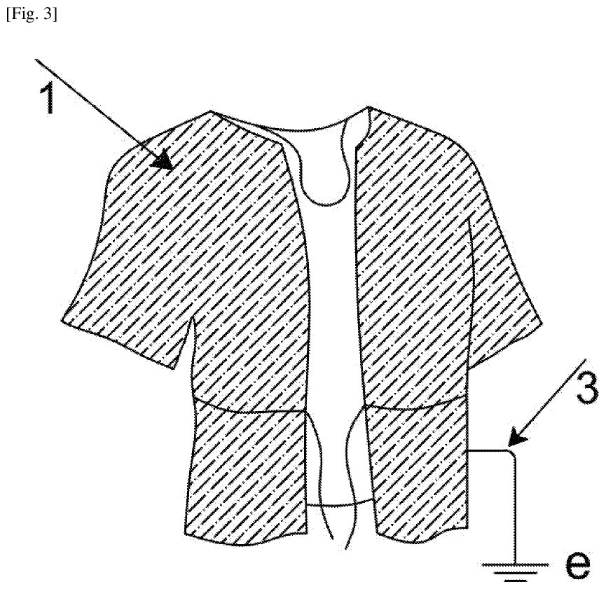

Yet another embodiment of the invention is shown in FIG. 3, schematically. In FIG. 3, (1) is the wearable clothing, and (3) is the ground wire.

By means of the wearable clothing in FIG. 1, it's possible to protect children's health against electromagnetic radiation from tablet and/or mobile phone and/or laptop and/or game-net and/or game-pad while they are using them.

Usually, we see children around the world that are per diem playing tablet and/or mobile phone and/or laptop and/or game-net and/or game-pad. The children are exposed to electromagnetic waves radiated by tablet and/or mobile phone and/or laptop and/or game-net and/or game-pad every second while playing the game and their bodies are affected by it.

By using the wearable clothing by children it's possible to eliminate the risk of electromagnetic radiation on children bodies and/or decrease to minimum level.

1. A wearable clothing made of anti-radiation and anti-electromagnetic waves fibers where an element enters into fabric with a special chemical technique and make the wearable clothing resistant to electromagnetic radiation, wherein the element is an element selected from row 6 of chemical table consisting of lead, gold, mercury, platinum, etc., and the most resistant elements are used to deal with radiation in the construction of anti-electromagnetic radiation wearable clothing.

2. A wearable clothing according to claim 1, wherein various geometric shape and design are used for children without limitation in type, shape and size.

3. A wearable clothing according to claim 1 and 2, wherein the wearable can be used by children, teenagers and anyone that uses tablet and/or mobile phone and/or laptop and/or game-net and/or game-pad anywhere and anytime and important features of the wearable clothing are anti-electromagnetic radiation, light weight, flexible, having radiation resistance in all regions of the wearable clothing, having high durability in anti-radiation and anti-electromagnetic waves properties.

4. A wearable clothing substantially as hereinbefore described, with reference to the accompanying drawings.
